(19) United States
(12) Patent Application Publication
(10) Pub. No.: US 2012/0039271 A1
(43) Pub. Date: Feb. 16, 2012

(54) METHOD AND APPARATUS FOR DISTRIBUTED SCHEDULING IN WIRELESS MESH NETWORK BASED ON OFDMA

(75) Inventors: Hyun Jae KIM, Incheon (KR); Woo Ram Shin, Daejeon (KR); An Seok Lee, Daejeon (KR); Kwang Jae Lim, Daejeon (KR); Keun Young Kim, Seongnam-si (KR); Ji Hung Kim, Daejeon (KR); Dong Seung Kwon, Daejeon (KR)

(73) Assignee: Electronics and Telecommunications Research Institute, Daejeon (KR)

(21) Appl. No.: 13/195,397

(22) Filed: Aug. 1, 2011

(30) Foreign Application Priority Data
Aug. 3, 2010 (KR) 10-2010-0075073
Dec. 21, 2010 (KR) 10-2010-0131463

(51) Int. Cl. H04W 72/04

(52) U.S. Cl. 370/329

(57) ABSTRACT

A method and apparatus for distributed scheduling within an orthogonal frequency division multiple access (OFDMA)-based wireless mesh network may be provided. A requester and a granter in the wireless mesh network may perform three way-handshaking using distributed scheduling messages. A plurality of distributed scheduling messages may use different sub-channels. The request may reserve sub-channels to be used by respective scheduling messages.

### CROSS-REFERENCE TO RELATED APPLICATION(S)

This application claims the benefit of Korean Patent Application Nos. 10-2010-0075073 and 10-2010-0131463, filed on Aug. 3, 2010 and Dec. 21, 2010, respectively, in the Korean Intellectual Property Office, the disclosures of which are incorporated herein by reference.

### BACKGROUND

1. Field of the Invention

The present invention relates to a method and apparatus for distributed scheduling in an orthogonal frequency division multiple access (OFDMA)-based wireless mesh network.

2. Description of the Related Art

In a wireless mesh network system, a node that requests a resource may use a distributed media access scheme that accesses a control channel based on a time-domain orthogonal frequency-division multiplexing (OFDM) and a time division multiplexing (TDM) scheme.

The IEEE 802.16 mesh and IEEE 802.11-based schemes are representative schemes that use the OFDM scheme and the TDM scheme.

According to a conventional distributed media access scheme of the OFDM scheme and the TDM scheme, resources may be used by being divided based on a time domain. A node that requests a resource may occupy one of the resources divided based on the time domain and may transmit request information.

A node may scan whether another node requests a resource from the node, and may use remaining resources excluding the occupied resource for transmission of the request information, for the scanning operation.

Due to a characteristic of a control channel that is divided based on a time, a great amount of time delay may occur when a three way-handshaking process that is commonly used in a distributed scheduling scheme is performed.

Accordingly, to satisfy a quality-of-service (QoS), there is a desire for a resource allocation method that transmits a message and a frame structure in which the three way-handshaking process is promptly performed.

### SUMMARY

An aspect of the present invention provides a distributed scheduling method and apparatus that may use a frame structure that enables resource access for each sub-channel.

Another aspect of the present invention also provides a three way-handshaking method and apparatus that reduces a time delay.

According to an aspect of the present invention, there is provided a three way-handshaking method in an orthogonal frequency division multiple access (OFDMA)-based wireless mesh system, the method including transmitting, to a grant terminal, a first distributed scheduling message including a request information element (IE), receiving, from the grant terminal, a second distributed scheduling message including a grant IE, and transmitting, to the grant terminal, a third distributed scheduling message including a confirmation IE, and the first distributed scheduling message, the second distributed scheduling message, and the third distributed scheduling message are transmitted via different sub-channels.

The request IE may include data transmission region information indicating a region to which data is to be transmitted.

The grant IE may include information associated with whether a region corresponding to the data transmission region information is available and information associated with an available region in the region corresponding to the data transmission region information.

The confirmation IE may indicate that the grant IE is received.

The sub-channels may be separated based on a frequency domain of a communication channel.

Each sub-channel may correspond to at least one logical resource unit (LRU) included in a sub-frame (SF).

The SF may include at least one sub-carrier, each sub-carrier may include at least one OFDMA symbol, and an OFDMA symbol may correspond to an LRU.

A number of the at least one sub-carriers may be 18 and a number of the at least one OFDMA symbol included in each sub-carrier may be 6.

A plurality of grant terminals may be used.

A plurality of second distributed scheduling messages transmitted from the plurality of grant terminals may be transmitted via different sub-channels.

The three way-handshaking method may further include allocating a first sub-channel, reserving a second sub-channel, and reserving a third sub-channel.

The first distributed scheduling message may be transmitted via the first sub-channel, the second distributed scheduling message may be transmitted via the second sub-channel, and the third distributed scheduling message may be transmitted via the third sub-channel.

A location of the second sub-channel and a location of the third sub-channel may be determined based on a location of the first sub-channel.

The first distributed scheduling message may include information to identify the second sub-channel.

According to another aspect of the present invention, there is provided a three way-handshaking method in an OFDMA-based wireless mesh system, the method including receiving, from a request terminal, a first distributed scheduling message including a request IE, transmitting, to the request terminal, a second distributed scheduling message including a grant IE, and receiving, from the request terminal, a third distributed scheduling message including a confirmation IE, and the first distributed scheduling message, the second distributed scheduling message, and the third distributed scheduling message are transmitted via different sub-channels.

A sub-channel through which the second distributed scheduling message is transmitted may be allocated by the request terminal.

According to still another aspect of the present invention, there is provided a terminal included in an OFDMA-based wireless mesh network, the terminal including a transceiver to transmit and receive a distributed scheduling message via a sub-channel of a distributed scheduling SF included in a scheduling and data frame (SDF), and a controller to generate a distributed scheduling message to be transmitted and to process a received distributed scheduling message.

The distributed scheduling message may include a transmission request message, a transmission grant message, and a transmission confirmation message.

The transmission request message, the transmission grant message, and the transmission confirmation message may be transmitted via different sub-channels.

The SDF may include at least two distributed scheduling SF.

Information associated with a configuration of the SDF may be transmitted through an IE within a broadcasting message included in a network configuration frame.

The information associated with the configuration of the SDF may include information associated with a location of a distributed scheduling SF, period information, and information associated with whether to use switching gap (SG).

Nodes in a predetermined scope of the network may use SDFs in the same structure.

The predetermined scope may be set based on a distance among nodes, a density of the nodes, and interference based on a difference among structures of SDFs used in an adjacent area.

The SDF may include at least one data frame.

The data frame may include at least one sub-carrier, and each sub-carrier may include at least one OFDM symbol.

Additional aspects, features, and/or advantages of the invention will be set forth in part in the description which follows and, in part, will be apparent from the description, or may be learned by practice of the invention.

### EFFECT

Example embodiments may provide a distributed scheduling method and apparatus that may use a frame structure that enables resource access for each sub-channel.

Example embodiments may provide a three way-handshaking method and apparatus that reduces a time delay.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a structure of a frame used in a wireless mesh network according to an embodiment of the present invention;

FIG. 2 illustrates a structure of a scheduling and data frame (SDF) according to an embodiment of the present invention;

FIG. 3 illustrates a structure of another SDF according to an embodiment of the present invention;

FIG. 4 illustrates a structure of still another SDF according to an embodiment of the present invention;

FIG. 5 illustrates a configuration of sub-channels in a distributed scheduling sub-frame (DSCH SF) and a configuration of sub-channels in a data sub-frame (DATA SF) according to an embodiment of the present invention;

FIG. 6 illustrates a flow of a signal to describe a three way-handshaking method in an orthogonal frequency division multiple access (OFDMA)-based wireless mesh system according to an embodiment of the present invention;

FIG. 7 illustrates a frame structure of a three way-handshaking process according to an embodiment of the present invention; and

FIG. 8 illustrates a configuration of a terminal according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

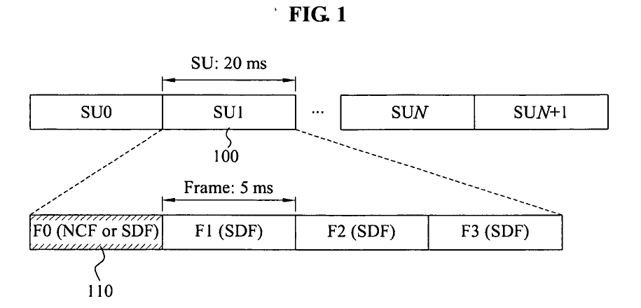

FIG. 1 illustrates a structure of a frame used in a wireless mesh network according to an embodiment of the present invention.

A super-frame (SU) 100 is a frame of a largest unit used in the wireless mesh network.

The single SU 100 may be used for 20 milliseconds (ms). That is, a length of the SU 100 may be 20 ms.

The SU 100 may include at least one frame. For example, an SU may include four frames, and a length of each frame may be 5 ms.

An SU may include a network configuration frame (NCF) and a scheduling and data frame (SDF).

The NCF may correspond to a section for transmission of information associated with entry to a network or information broadcasted by each node in the network.

The SDF may correspond to a section for transmission of distributed scheduling information and data.

For example, a first frame 110 of the SU 100 may be an NCF or an SDF.

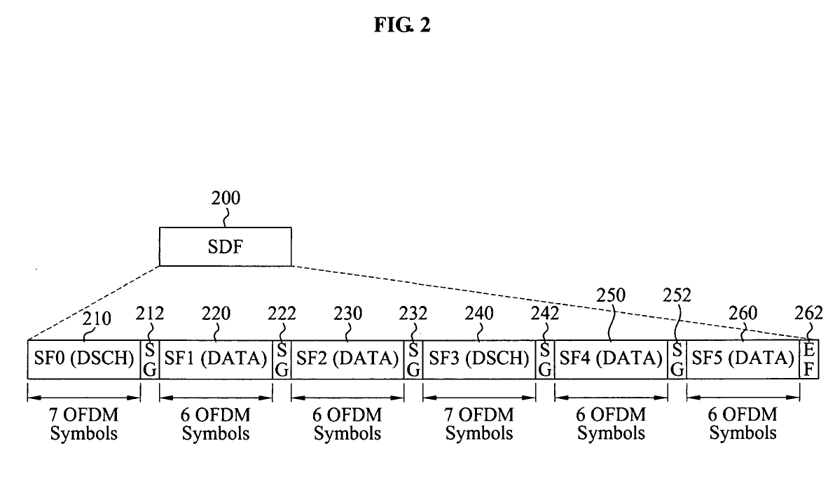

FIG. 2 illustrates a structure of an SDF according to an embodiment of the present invention.

A first SDF 200 may include a sub-frame (SF), a switching gap (SG), and an end of frame (EF).

At least one SF included in an SDF may be identified by a number, increased by one starting from zero. For example, a first SF in the SDF may be an “SF0.”

The first SDF 200 may include an “SF0” 210, an SG “212”, an “SF1” 220, an “SG” 222, an “SF2” 230, an “SG” 232, an “SF3” 240, an “SG” 242, an “SF4” 250, an “SG” 252, an “SF5” 260, and an “EF” 262.

The first SF corresponding to the “SF0” 210 and a fourth SF corresponding to the “SF3” 240 may be distributed scheduling (DSCH) SFs.

Remaining SFs, that is, the “SF1” 220, the “SF2” 230, the “SF4” 250, and the “SF5” 260, may be data (DATA) SFs.

Each of the “SF0” 210 and the “SF3” 240 may include seven orthogonal frequency division multiplexing (OFDM) symbols.

Each of the “SF1” 220, the “SF2” 230, the “SF4” 250, and the “SF5” 260 may include six OFDM symbols.

As illustrated in FIG. 2, the first SDF 200 may include at least two DSCH SFs.

Nodes included in a network may exchange, using DSCH SFs, a request message, a grant message, a confirm message in a three way-handshaking process. After confirmation is completed, a node that transmits a request message may transmit data using a confirmed DATA SF.

The first SDF 200 may have a structure including two DSCH SFs 210 and 240 in a single SDF. The structure may reduce a time delay caused by a distributed three way-handshaking process.

That is, a request operation, a grant operation, and a confirmation operation are completed within a time, corresponding to a length of a single frame, of 5 ms.

A structure of the first SDF 200 provides a high degree of freedom of using a resource, since the DATA SFs corresponding to the DATA SFs 220, 230, 250, and 260 may be used by other nodes.

Here, the first SDF 200 may use “SG” 212, “SG” 222, “SG” 232, “SG” 242, and “SG” 252 relatively frequently and thus, a total frame structure may provide a low resource efficiency.

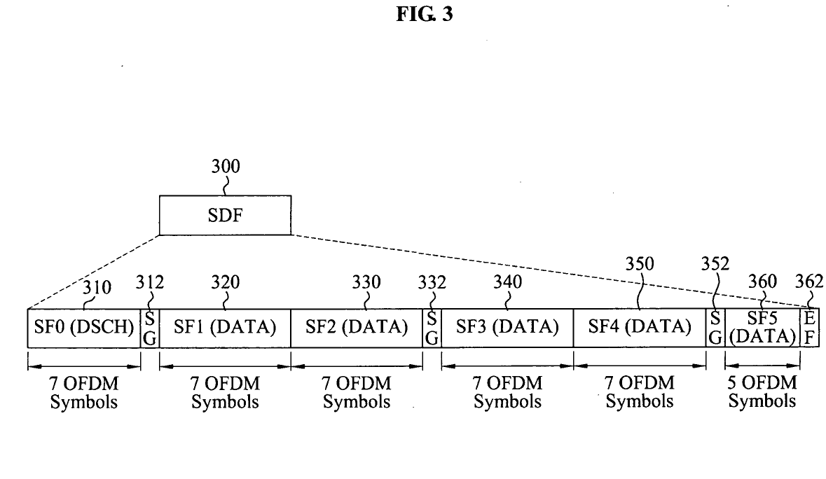

FIG. 3 illustrates a structure of another SDF according to an embodiment of the present invention.

A second SDF 300 may include an “SF0” 310, an “SG” 312, an “SF1” 320, an “SF2” 330, an “SG” 332, an “SF3” 340, an “SF4” 350, an “SG” 352, an “SF5” 360, and an “EF” 362, sequentially.

The “SF0” 310 may be a DSCH SF.

Remaining SFs, that is, the “SF1” 320, the “SF2” 330, the “SF3” 340, the “SF4” 350, and the “SF5” 360, may be DATA SFs.

Each of the “SF0” 310, the “SF1” 320, the “SF2” 330, the “SF3” 340, the “SF4” 350 may include seven OFDM symbols.

The “SF5” 360 may include five OFDM symbols.

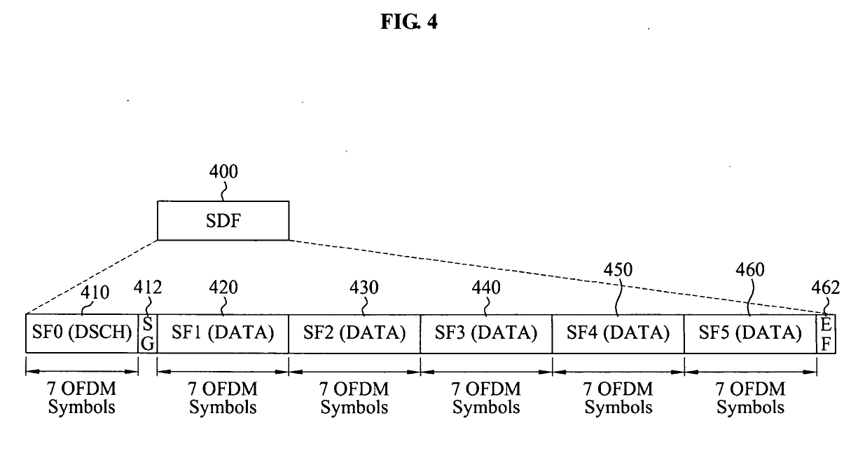

FIG. 4 illustrates a structure of still another SDF according to an embodiment of the present invention.

A third SDF 400 may include an “SF0” 410, an “SG” 412, an “SF1” 420, an “SF2” 430, an “SF3” 440, an “SF4” 450, an “SF5” 460, and an “EF” 462, sequentially.

The “SF0” 410 may be a DSCH SF.

Remaining SFs, that is, the “SF1” 420, the “SF2” 430, the “SF3” 440, the “SF4” 450, and the “SF5” 460, may be DATA SFs.

Each of the “SF0” 410, the “SF1” 420, the “SF2” 430, the “SF3” 440, the “SF4” 450, and the “SF5” 460 may include seven OFDM symbols.

The second SDF 300 and the third SDF 400 may include one DSCH SF, respectively.

The structures of the second SDF 300 and the third SDF 400 may reduce overhead caused by SGs so as to effectively use data. When the second SDF 300 and the third SDF 400 are used, each node may use a plurality of SFs as a resource allocation unit so as to improve frequency efficiency.

Information associated with a structure of an SDF, for example, the first SDF 200, the second SDF 300, and the third SDF 400, may be broadcasted through an information element (IE) associated with the structure of the SDF, the IE being included in a broadcasting message in an NCF. Therefore, based on 1) a number of nodes, and 2) a characteristic of an amount of data transmitted between nodes, 1) position information associated with a DSCH SF or DATA SF, 2) period information associated with a DSCH SF or a DATA ST, and 3) information associated with whether an SG is used may be broadcasted by an SDF IE.

Through the broadcasting, SDFs of adjacent nodes in a network may be set to have the same structure.

That is, nodes included in a predetermined scope of the network may use SDFs having the same structure, and the predetermined scope may be determined based on 1) a distance among nodes, 2) a density of the nodes, and 3) interference based on a difference among structures of SDFs used in an adjacent area.

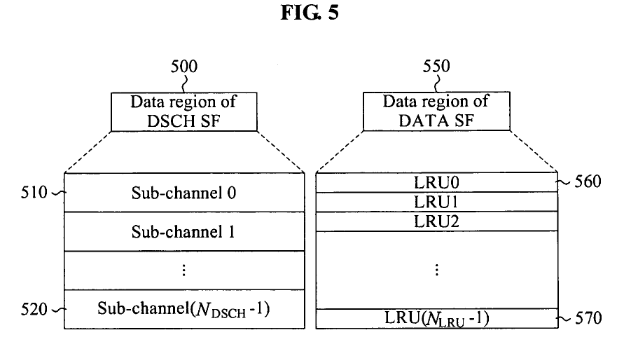

FIG. 5 illustrates a configuration of sub-channels in a DSCH SF and a configuration of sub-channels in a DATA SF according to an embodiment of the present invention.

As illustrated in FIG. 5, a data region 500 of the DSCH SF and a data region 550 of the DATA SF may include a plurality of sub-channels divided based on a frequency domain of a communication channel.

A sub-channel of the DSCH SF may be a bundle of logical resource units (LRUs). That is, the sub-channel may be at least one LRU in the DSCH SF.

The data region 500 of the DSCH SF may include at least one sub-carrier, and a sub-carrier includes at least one OFDMA symbol. An LRU may correspond to an OFDMA symbol.

The data region 500 of the DSCH SF may include 18 sub-carriers, and each sub-carrier may include six OFDMA symbols. A bundle of a predetermined number of LRUs among the 18×6 LRUs in the DSCH SF may be used as a basic resource unit, that is, a sub-channel.

N_{DSCH} may denote may denote a number of the LRU bundles, that is, a number of sub-channels. That is, a “sub-channel 0” 610 may correspond to a first sub-channel, and a “sub-channel (N_{DSCH}−1)” 620 may correspond to a last sub-channel.

To improve resource allocation efficiency, a sub-channel of the DATA SF may be an LRU.

The data region 550 of the DATA SF may include 18 sub-carriers. Also, as described in the descriptions with reference to FIGS. 2 through 4, each sub-carrier may include five, six, or seven OFDMA symbols.

That is, 18×5, 18×6, or 18×7 LRUs may be used, respectively, as a basic resource unit in the DATA SF.

N_{LRU} may denote a number of LRUs. Accordingly, the data region 550 of the DATA SF may include an “LRU0” 560 through an “LRU (N_{LRU}−1)” 570. The “LRU0” 560 may correspond to a first LRU, and “LRU (N_{LRU}−1)” 570 may correspond to a last LRU.

Configuration information of an SF, for example, the N_{DSCH}, may be transmitted by a broadcasting message. Therefore, adjacent nodes may use structures of DSCH SFs having the same number of sub-channels.

The frame structure described in the foregoing may enable resource access for each sub-channel, and may improve a probability of success in resource access. The frame structure may be set to be flexible through a broadcasting message.

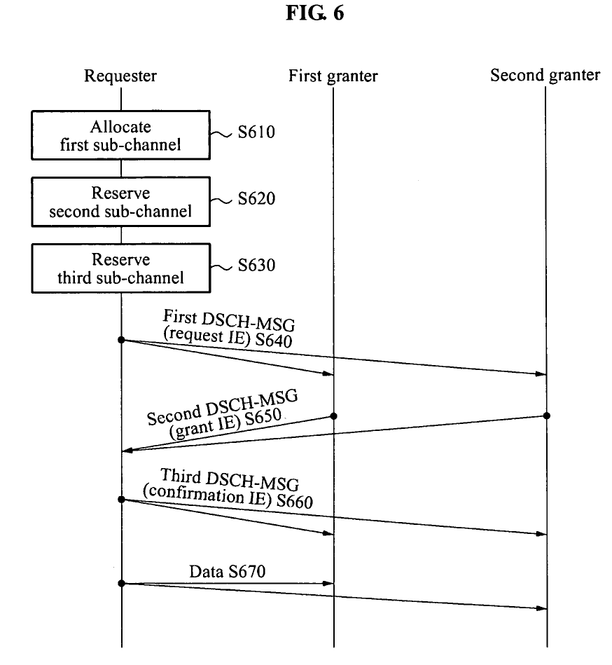

FIG. 6 illustrates a flow of a signal to describe a three way-handshaking method in an OFDMA-based wireless mesh system according to an embodiment of the present invention

A requester may correspond to a node that is to transmit data, that is, a terminal in a network.

A first granter and a second granter may be nodes to which the requester is to transmit data. Here, at least one granter may be used.

A first distributed scheduling message (DSCH-MSG), a second DSCH-MSG, a third DSCH-MSG may be transmitted via different sub-channels.

Therefore, the requester may allocate or reserve three sub-channels to transmit three scheduling messages.

In operation S610, the requester may allocate a first sub-channel to transmit the first DSCH-MSG.

In operation S620, the requester may reserve a second sub-channel to receive the second DSCH-MSG.

As illustrated in FIG. 6, at least two granters may be used. A plurality of second DSCH-MSGs may be transmitted from a plurality of granters via different sub-channels. Therefore, a plurality of second sub-channels may be used, and the plurality of second sub-channels may be reserved by the requester.

In operation S630, the requester may reserve a third sub-channel to transmit the third DSCH-MSG.

In operation S640, the requester may transmit the first DSCH-MSG to the granters via the first sub-channel. Each of the granters may receive the first DSCH-MSG. The first DSCH-MSG may be transmitted by broadcasting.

The first DSCH-MSH may be a transmission request message. The first DSCH-MSG may include a request information element (IE).

The request IE may include an identifier (ID) of each granter, and may include data transmission region information indicating a region to which the requester is to transmit data.

The region to which the requester is to transmit data may indicate a predetermined section including at least one basic resource unit, that is, at least one LRU, in the data region 550 of the DATA SF.

The first DSCH-MSG may include information for identifying a second sub-channel through which the second DSCH-MSG is to be transmitted.

In operation S650, the granters may transmit second DSCH-MSGs via second sub-channels, respectively. The requester may receive the second DSCH-MSGs. As described in the foregoing, the second sub-channels may be reserved by the requester.

The granters may transmit the second DSCH-MSGs via different second sub-channels.

Each second DSCH-MSG may correspond to a grant message. The second DSCH-MSG may include a grant IE.

The granters may determine whether a region corresponding to the data transmission region information included in the request IE is used by adjacent nodes. The granters may generate: 1) information associated with whether the region corresponding to the data transmission region information is actually available, and 2) information associated with an region actually available among the regions corresponding to the data transmission region information.

The grant IE may include: 1) information associated with whether the region corresponding to the data transmission region information is actually available, and 2) information associated an available region among the regions corresponding to the data transmission region information, which are generated by a granter.

In operation S660, the requester may transmit the third DSCH-MSG to the granters via the third sub-channel. Each granter may receive the third DSCH-MSG.

The third DSCH-MSG may be a confirmation message. The third DSCH-MSG may include a confirmation IE.

The confirmation IE may include an acknowledge message indicating that the grant IE is received. The confirmation IE may include information associated with the available region included in the grant IE.

In operation S670, when a three way-handshaking process is completed, the requester may transmit data based on a resource within a confirmed region. That is, the granters may receive the transmitted data.

As described in the foregoing, the requester may allocate in advance, to each granter, a region, that is, a sub-channel, where the granters attempt grant. In this instance, reservation of a three way-handshaking message transmission region may minimize a delay of a control message.

The three way-handshaking method is promptly performed and thus, a time delay may be minimized so as to satisfy a quality of service (QoS). Since the time delay is minimized, a QoS, for example, a voice over internet protocol (VoIP) service, a real-time video service, and the like, may be satisfied.

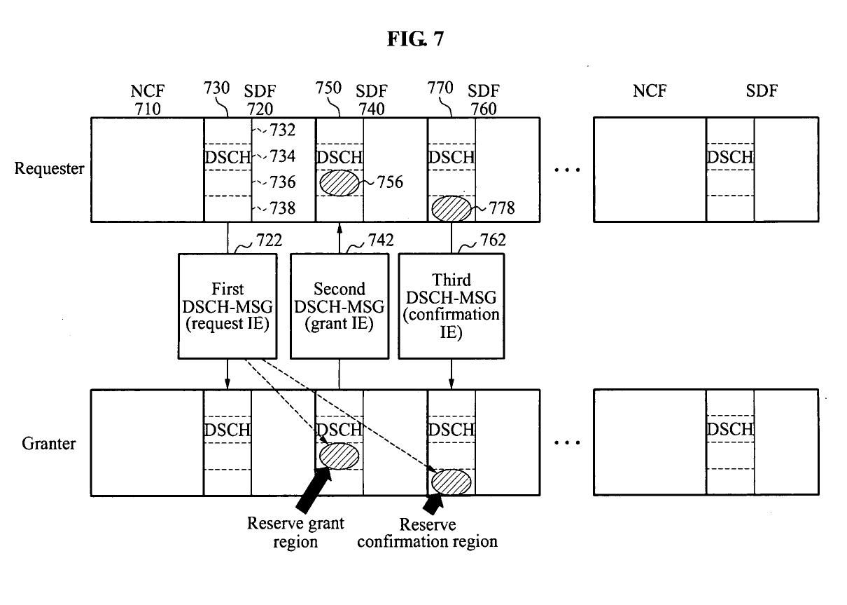

FIG. 7 illustrates a frame structure of a three way-handshaking process according to an embodiment of the present invention.

A requester may request data from a granter in a mesh network.

A first NCF 710, a first SDF 720, a second SDF 740, and a third SDF 760 are frames used for communication between the requester and the granter.

The first SDF 720 may include a first DSCH SF 730. The second SDF 740 may include a second DSCH SF 750. The third SDF 760 may include a third DSCH SF 770.

Each of the DSCH SFs 730, 750, and 770 may include four sub-channels. A “sub-channel 0” 732, a “sub-channel 1” 734, a “sub-channel 2” 736, and a “sub-channel 3” 738 are included in the first DSCH SF 730, in an order from top to bottom.

The requester may allocate a sub-channel 1 for a first DSCH MSG 722. The requester may reserve a sub-channel 2 for a second DSCH MSG 742, and may reserve a sub-channel 3 for a third DSCH MSG 762.

The requester may reserve the sub-channel 1, the sub-channel 2, and the sub-channel 3 for the first DSCH MSG 722, the second DSCH MSG 742, and the third DSCH MSG 762, respectively. Accordingly, a location of a sub-channel used by the second DSCH MSG 742 and a location of a sub-channel used by the third DSCH MSG 762 may be determined based on a location of a sub-channel used by the first DSCH MSG 722.

The requester may transmit the first DSCH MSG 722 including a request IE via the “sub-channel 1” 734 of the first SDF 720.

The granter may transmit the second DSCH MSG 742 including a grant IE via a “sub-channel 2” 756 of the second SDF 740.

The requester may transmit the third DSCH MSG 762 including a confirmation IE via a “sub-channel 3” 778 of the third SDF 760.

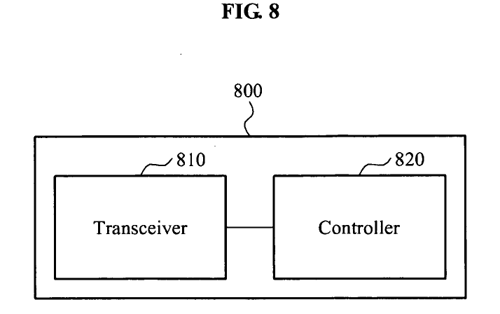

FIG. 8 is a diagram illustrating a configuration of a terminal according to an embodiment of the present invention.

A terminal 800 may correspond to a node in an OFDMA-based wireless mesh network, which performs as a requester and a granter.

The terminal 800 may include a transceiver 810 and a controller 820.

The transceiver 810 may transmit and receive a first DSCH MSG (transmission request message), a second DSCH MSG (transmission grant message), and a third DSCH MSG (transmission confirmation message). The DSCH MSGs may be transmitted via sub-channels of a DSCH SF included in an SDF.

The controller 820 may generate a DSCH MSG transmitted by the transceiver 810, and may process a DSCH MSG received by the transceiver 810.

The first DSCH MSG, the second DSCH MSG, and the third DSCH MSG may be transmitted via different sub-channels.

Descriptions described with reference to FIGS. 1 through 7 may be applicable to the present embodiment and thus, detailed descriptions will be omitted for conciseness.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A three way-handshaking method in an orthogonal frequency division multiple access (OFDMA)-based wireless mesh system, the method comprising:
transmitting, to a grant terminal, a first distributed scheduling message including a request information element (IE);
receiving, from the grant terminal, a second distributed scheduling message including a grant IE; and
transmitting, to the grant terminal, a third distributed scheduling message including a confirmation IE,
wherein the first distributed scheduling message, the second distributed scheduling message, and the third distributed scheduling message are transmitted via different sub-channels.

2. The method of claim 1, wherein:
the request IE comprises data transmission region information indicating a region to which data is to be transmitted;
the grant IE comprises information associated with whether a region corresponding to the data transmission region information is available and information associated with an available region in the region corresponding to the data transmission region information; and
the confirmation IE indicates that the grant IE is received.

3. The method of claim 1, wherein the sub-channels are separated based on a frequency domain of a communication channel.

4. The method of claim 1, wherein each sub-channel corresponds to at least one logical resource unit (LRU) included in a sub-frame (SF).

5. The method of claim 4, wherein the SF comprises at least one sub-carrier, each sub-carrier comprises at least one OFDMA symbol, and an OFDMA symbol corresponds to an LRU.

6. The method of claim 5, wherein a number of the at least one sub-carriers is 18 and a number of the at least one OFDMA symbol included in each sub-carrier is 6.

7. The method of claim 1, wherein a plurality of grant terminals is used, and a plurality of second distributed scheduling messages transmitted from the plurality of grant terminals is transmitted via different sub-channels.

8. The method of claim 1, further comprising:
allocating a first sub-channel;
reserving a second sub-channel; and
reserving a third sub-channel,
wherein the first distributed scheduling message is transmitted via the first sub-channel, the second distributed scheduling message is transmitted via the second sub-channel, and the third distributed scheduling message is transmitted via the third sub-channel.

9. The method of claim 8, wherein a location of the second sub-channel and a location of the third sub-channel are determined based on a location of the first sub-channel.

10. The method of claim 8, wherein the first distributed scheduling message comprises information to identify the second sub-channel.

11. A three way-handshaking method in an orthogonal frequency division multiple access (OFDMA)-based wireless mesh system, the method comprising:
receiving, from a request terminal, a first distributed scheduling message including a request information element (IE);
transmitting, to the request terminal, a second distributed scheduling message including a grant IE; and
receiving, from the request terminal, a third distributed scheduling message including a confirmation IE,
wherein the first distributed scheduling message, the second distributed scheduling message, and the third distributed scheduling message are transmitted via different sub-channels.

12. The method of claim 11, wherein a sub-channel through which the second distributed scheduling message is transmitted is allocated by the request terminal.

13. A terminal included in an orthogonal frequency division multiple access (OFDMA)-based wireless mesh network, the terminal comprising:
a transceiver to transmit and receive a distributed scheduling message via a sub-channel of a distributed scheduling sub-frame (SF) included in a scheduling and data frame (SDF); and
a controller to generate a distributed scheduling message to be transmitted and to process a received distributed scheduling message.

14. The terminal of claim 13, wherein the distributed scheduling message includes a transmission request message, a transmission grant message, and a transmission confirmation message, and the transmission request message, the transmission grant message, and the transmission confirmation message are transmitted via different sub-channels.

15. The terminal of claim 13, wherein the SDF comprises at least two distributed scheduling SF.

16. The terminal of claim 13, wherein information associated with a configuration of the SDF is transmitted through an information element (IE) within a broadcasting message included in a network configuration frame.

17. The terminal of claim 16, wherein the information associated with the configuration of the SDF comprises information associated with a location of a distributed scheduling SF, period information, and information associated with whether to use switching gap (SG).

18. The terminal of claim 13, wherein nodes in a predetermined scope of the network use SDFs in the same structure, and the predetermined scope is set based on a distance among nodes, a density of the nodes, and interference based on a difference among structures of SDFs used in an adjacent area.

19. The terminal of claim 13, wherein the SDF comprises at least one data frame.

20. The terminal of claim 13, wherein the data frame comprises at least one sub-carrier, and each sub-carrier comprises at least one OFDM symbol.
